(19) United States
(12) Patent Application Publication
(10) Pub. No.: US 2025/0046956 A1
(43) Pub. Date: Feb. 6, 2025

(54) BATTERY MODULE CONNECTING MEMBER AND BATTERY MODULE ASSEMBLY INCLUDING THE SAME

(71) Applicant: HYUNDAI MOBIS CO., LTD., Seoul (KR)

(72) Inventors: Yeon Jun WOO, Yongin-si (KR); Seung Jun LEE, Yongin-si (KR); Dae Hyeon JU, Yongin-si (KR)

(73) Assignee: HYUNDAI MOBIS CO., LTD., Seoul (KR)

(21) Appl. No.: 18/614,043

(22) Filed: Mar. 22, 2024

(30) Foreign Application Priority Data
Aug. 3, 2023 (KR) 10-2023-0101474

(51) Int. Cl. H01M 50/517; H01M 50/242; H01M 50/503

(52) U.S. Cl. CPC H01M 50/517; H01M 50/242; H01M 50/503

(57) ABSTRACT

According to an aspect of the present invention, a battery module connecting member mounted between side surfaces of battery modules may include a body extending along the side surface of the battery module and seating portions provided at front and rear ends of the body and protruding from at least one of both side surfaces of the body to be seated on terminal blocks provided on front and rear surfaces of the battery module.

### CROSS-REFERENCE TO RELATED APPLICATION

This application claims priority to and the benefit of Korean Patent Application No. 10-2023-0101474, filed on Aug. 3, 2023, the disclosure of which is incorporated herein by reference in its entirety.

### BACKGROUND

### 1. Field of the Invention

The present invention relates to a battery module, and more particularly, to a battery module connecting member connected between battery modules to reinforce rigidity, and a battery module assembly including the same.

### 2. Discussion of Related Art

Unlike primary batteries, which cannot be recharged, secondary batteries are batteries that can be charged and discharged. Secondary batteries are used not only in small high-tech electronic devices such as mobile phones, laptops, and computers, but also as power sources for energy storage systems (ESSs), electric vehicles, and hybrid vehicles.

Secondary batteries, which are widely used in energy storage systems and electric vehicles, may be classified into lithium-ion batteries, lithium polymer batteries, nickel cadmium batteries, nickel hydrogen batteries, and nickel zinc batteries. Such secondary batteries are repeatedly charged and discharged at an output voltage of approximately 25 V to 42 V per unit cell. Therefore, when higher output voltage and power capacity are required, multiple battery cells are connected in series to form battery modules, or the battery modules are connected in series or parallel and other circuits are added to form a battery pack.

As electric vehicle specifications are becoming more diverse, modules with various battery cell connection methods are being developed, and conventional battery modules are assembled by welding and attaching a connecting member directly to a battery case.

However, this is only possible through welding when assembling the conventional connecting member to a case, and deformation may occur during welding, which may cause interference between battery modules. Additionally, when connecting members are applied on both sides of the battery modules, it is difficult to assemble swollen battery modules.

### SUMMARY OF THE INVENTION

The present invention is directed to providing a battery module connecting member in which a connecting member is mounted along a side surface of a battery module, and thus swelling may be prevented from occurring in a battery module, the side pressure of the battery module may be maintained, and heat transfer between battery modules may be blocked, and a battery module assembly including the same.

The present invention is also directed to providing a battery module connecting member in which seating portions constituting a connecting member are provided to have a symmetrical shape at front and rear ends thereof, and thus the connecting member may be used without distinction between the front and rear, thereby improving workability and shortening work time, and a battery module assembly including the same.

According to an aspect of the present invention, there is provided a battery module connecting member mounted between sides of battery modules, which includes a body extending along the side surface of the battery module and seating portions provided at front and rear ends of the body and protruding from at least one of both side surfaces of the body to be seated on terminal blocks provided on front and rear surfaces of the battery module.

The seating portion may include a first seating portion provided to protrude to one side and a second seating portion formed to be stepped from the first seating portion and provided to protrude to the other side from the first seating portion.

The first seating portion may be seated on a lower surface of the terminal blocks, and the second seating portion may be seated on an upper surface of the terminal blocks.

The seating portion may include a first seating portion that protrudes to one side and a second seating portion formed to have the same height as the first seating portion and provided to protrude to the other side from the first seating portion.

The seating portions may have a symmetrical shape with respect to the body.

The seating portions may have a step shape on which the terminal blocks are seated.

An insertion hole into which an electrical component is inserted may be formed in an upper surface of the seating portion.

The body may have a rectangular parallelepiped shape extending along the side surface of the battery module, and a side surface of the seating portion may be formed as a curved surface.

The body may be made in a hollow shape, and reinforcing ribs may be provided in multiple stages inside the body.

According to another aspect of the present invention, there is provided a battery module connecting member including battery modules and a battery module connecting member which is mounted between adjacent side surfaces of the battery modules and connects the battery modules.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a battery module connecting member according to an embodiment of the present invention;

FIG. 2 is a front view illustrating the battery module connecting member according to the embodiment of the present invention;

FIG. 3 is a perspective view illustrating a battery module assembly according to an embodiment of the present invention;

FIG. 4 is a front view illustrating the battery module assembly according to the embodiment of the present invention;

FIG. 5 is a plan view illustrating the battery module assembly according to the embodiment of the present invention; and

FIG. 6 is a perspective view illustrating a battery module connecting member according to another embodiment of the present invention.

### DETAILED DESCRIPTION OF EXEMPLARY EMBODIMENTS

Since the present invention may be changed in various ways and have various embodiments, specific embodiments will be described in detail below. However, this is not intended to limit the present invention to specific embodiments, and it should be understood to include all transformations, equivalents, and substitutes that are included in the spirit and technical scope of the present invention. In describing the present invention, when it is determined that a detailed description of related known technology may obscure the gist of the present invention, the detailed description will be omitted.

Although the terms “first,” “second,” and the like may be used herein to describe various components, these components should not be limited by these terms. These terms are only used to distinguish one component from another component.

Terms used in this application are only used to describe specific embodiments and are not intended to limit the invention. Singular expressions include plural expressions unless the context clearly indicates otherwise. In this application, although terms such as “include” or “have” are intended to designate the presence of features, numbers, steps, operations, components, parts, or combinations thereof described in the specification, it should be understood that the possibility of the presence or addition of one or more other features numbers, steps, operations, components, parts, or combinations thereof is not precluded.

In addition, throughout the specification, when “connected” is used, this does not mean that two or more components are directly connected, but rather it may mean that two or more components are indirectly connected through other components, that they are connected not only physically but also electrically, or that they are integrated although referred to by different names depending on the location or function.

Hereinafter, embodiments of a battery module connecting member and a battery module assembly including the same according to the present invention will be described in detail with reference to the accompanying drawings, but in the description with reference to the accompanying drawings, identical or corresponding components will be assigned the same reference numbers and duplicate descriptions thereof will be omitted.

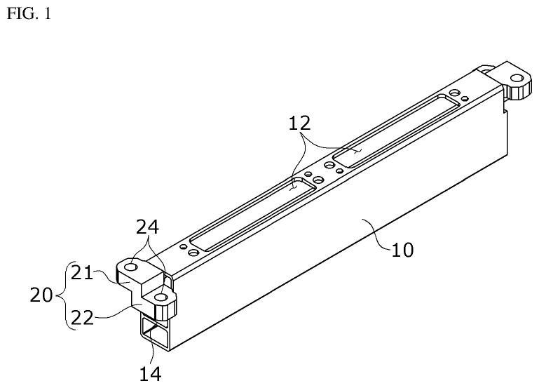

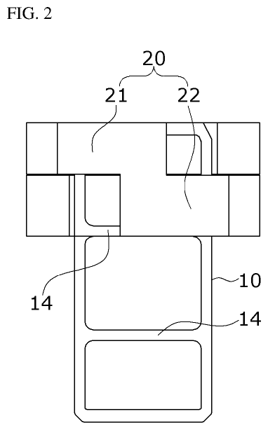

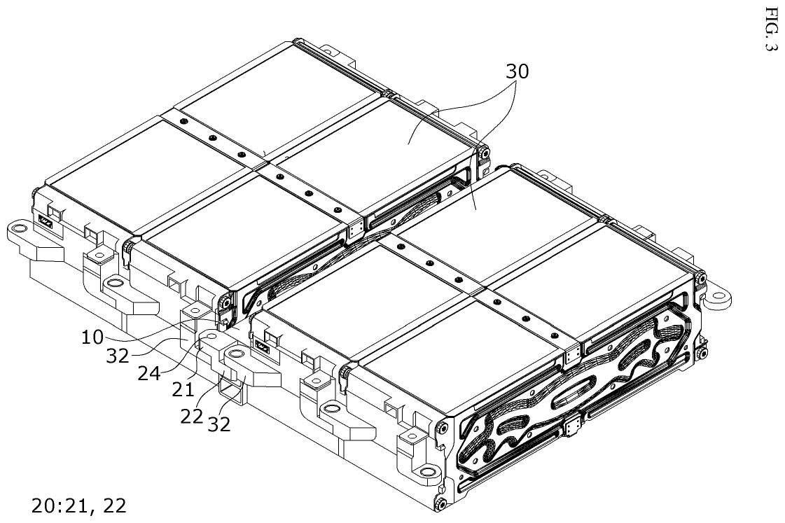

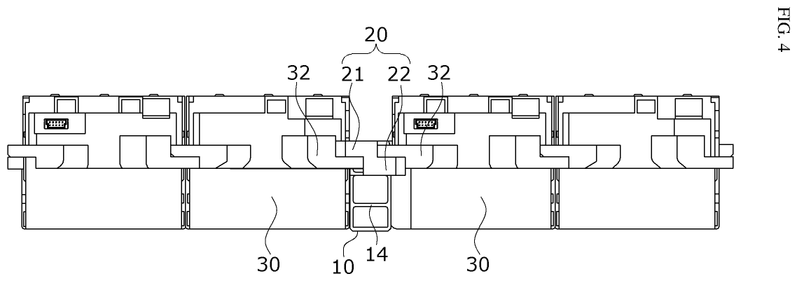

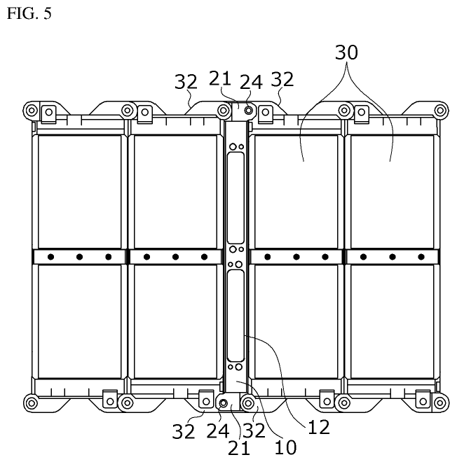

FIG. 1 is a perspective view illustrating a battery module connecting member according to an embodiment of the present invention, FIG. 2 is a front view illustrating the battery module connecting member according to the embodiment of the present invention, FIG. 3 is a perspective view illustrating a battery module assembly according to an embodiment of the present invention, FIG. 4 is a front view illustrating the battery module assembly according to the embodiment of the present invention, and FIG. 5 is a plan view illustrating the battery module assembly according to the embodiment of the present invention.

As shown, a battery module connecting member according to an embodiment of the present invention is a battery module connecting member mounted between side surfaces of battery modules and may include a body 10 extending along the sides of the battery modules, and seating portions 20 provided at front and rear ends of the body 10 and protruding from at least one of both side surfaces of the body to be seated on the terminal blocks 32 provided on front and rear surfaces of the battery module 30.

The body 10 may have a rectangular parallelepiped shape extending a predetermined length along the side surface of the battery module 30. The body 10 may have approximately half the side height of the battery module 30, but is not limited thereto.

Insertion holes 12 into which electrical components are inserted are formed in the upper surface of the body 10. Electrical components such as a cell monitoring unit (CMU) of the battery module 30 may be inserted into the insertion holes 12. In the drawings, the insertion holes 12 are illustrated as two insertion holes formed to be spaced apart from each other along the upper surface of the body 10, but are not limited thereto, and may be formed as one hole.

Referring to FIG. 4, since the body 10 is mounted along the side surface of the battery module 30, swelling can be prevented from occurring in the battery modules 30, the side pressure of the battery modules 30 can be maintained, and heat transfer between the battery modules 30 can be blocked.

Referring to FIG. 2, the body 10 is made in a hollow shape with an empty interior, and reinforcing ribs 14 may be provided in multiple stages inside the body 10. The reinforcing ribs 14 are provided in two stages in the drawing, but are not limited thereto and may be provided in three or more stages. Therefore, when the reinforcing ribs 14 are formed inside the body 10, which is formed long in a front-rear direction, the body 10 is resistant to torsion. Accordingly, the body 10 is firmly mounted on the battery module 30, and coupling between the battery modules 30 may be maintained. Additionally, a side surface of the seating portion 20 may have a curved shape.

The seating portion 20 may be provided to protrude at each of the front and rear ends of the body 10. The seating portions 20 may be provided to protrude so as to be seated on terminal blocks 32 provided on the front and rear surfaces of the battery module 30. Additionally, the side surface of the seating portion 20 may have the curved shape. The terminal blocks 32 are portions electrically connected to a battery cell stack constituting the battery module 30, and may be formed to protrude toward one side from the front and rear surfaces of the battery module 30.

In the embodiment, the seating portion 20 may include a first seating portion 21 provided to protrude to one side (left side) and a second seating portion 22 formed to be stepped from the first seating portion 21 and provided to protrude to the other side (right side) from the first seating portion 21. That is, the seating portion 20 may include the first seating portion 21 and the second seating portion 22 protruding in opposite directions at the front and rear ends of the body 10.

When the first seating portion 21 is formed at an upper portion and the second seating portion 22 is formed at a lower portion in a stepped manner, the first seating portion 21 and the second seating portion 22 may have a stepped shape. In this case, end portions of the terminal blocks 32 may be seated on an upper surface of the second seating portion 22 or may be seated in close contact with a lower surface of the first seating portion 21. Therefore, when one of two terminal blocks 32 provided in two adjacent battery modules 30 is seated on the upper surface of the second seating portion 22, and the other is seated on the lower surface of the first seating portion 21, the front and rear surfaces of the adjacent battery modules 30 are restricted from moving up and down, thereby ensuring that the connection between the battery modules 30 is firmly maintained.

Meanwhile, fastening holes 24 for fastening components such as wire clips are formed in the first seating portion 21 and the second seating portion 22.

Referring to FIG. 5, in the present embodiment, the seating portions 20 may have a symmetrical shape with respect to the body 10. In the drawing, the shape of the seating portions 20 are presented as described above, but it is not limited thereto, and the seating portions 20 just need to have a symmetrical shape. Accordingly, when the seating portions 20 have a symmetrical shape, the connecting member can be used without distinction between the front and rear, thereby improving workability. Additionally, the same pressure can be applied to a gap filler (not shown) disposed under the seating portion 20.

In addition, since the connecting member for battery module is only mounted between the battery modules 30 without being separately welded to a case (not shown) of a battery system, a welding process is omitted and work time can be reduced.

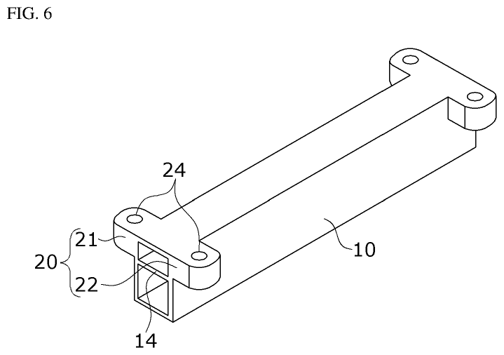

FIG. 6 is a perspective view illustrating a battery module connecting member according to another embodiment of the present invention.

Referring to the drawing, in the present embodiment, the seating portions 20 may be provided to protrude at the front and rear ends of the body 10. The seating portions 20 may be provided to protrude so as to be seated on the terminal blocks 32 provided on the front and rear surfaces of the battery module 30. Thus, the seating portion 20 may include a first seating portion 21 provided to protrude to one side (left side) and a second seating portion 22 provided to protrude to the other side (right side) from the first seating portion 21. That is, the seating portion 20 may include the first seating portion 21 and the second seating portion 22 protruding in opposite directions at the front and rear ends of the body 10.

In the present embodiment, unlike the above-described embodiment, the first seating portion 21 and the second seating portion 22 may protrude from both sides at the same height without being stepped from each other. Then, the first seating portion 21 and the second seating portion 22 may be seated on the upper surfaces of the terminal blocks 32 provided on the front and rear surfaces of the battery module 30.

Meanwhile, the battery module assembly according to the embodiment of the present invention may include battery modules 30 and a battery module connecting member that is mounted between adjacent side surfaces of the battery modules 30 and connects the battery modules 30.

A plurality of battery modules 30 may be arranged in parallel to form the battery module assembly. In the drawings, the battery modules 30 are illustrated as two units being connected, but this is not limited thereto and three or more units may be arranged in parallel depending on a battery system.

According to an embodiment of the present invention, since a connecting member is mounted along a side surface of a battery module, swelling can be prevented from occurring in the battery module, the side pressure of the battery module can be maintained, and heat transfer between battery modules can be blocked.

Also, according to an embodiment of the present invention, since seating portions constituting a connecting member are provided to have a symmetrical shape at front and rear ends thereof, the connecting member can be used without distinction between the front and rear, thereby improving workability and shortening work time.

Although the present invention has been described above with reference to specific embodiments, it should be understood that those skilled in the art may modify 10 and change the present invention in various ways without departing from the spirit and scope of the present invention as set forth in the claims below.

What is claimed is:

1. A battery module connecting member mounted between side surfaces of battery modules, comprising:
a body extending along the side surfaces of the battery modules; and
seating portions provided at front and rear ends of the body and protruding from at least one of both sides of the body to be seated on terminal blocks provided on front and rear surfaces of the battery modules, respectively.

2. The connecting member of claim 1, wherein one of the seating portions includes:
a first seating portion protruding to one side; and
a second seating portion stepped from the first seating portion and protruding to the other side from the first seating portion.

3. The connecting member of claim 2, wherein the first seating portion is seated on a lower surface of one of the terminal blocks, and the second seating portion is seated on an upper surface of the one of the terminal blocks.

4. The connecting member of claim 1, wherein the one of the seating portions includes:
a first seating portion that protrudes to one side; and
a second seating portion having the same height as the first seating portion and protruding to the other side from the first seating portion.

5. The connecting member of claim 1, wherein the seating portions have a symmetrical shape with respect to the body.

6. The connecting member of claim 1, wherein the seating portions have a step shape on which the terminal blocks are seated.

7. The connecting member of claim 1, wherein an upper surface of the seating portion has an insertion hole into which an electrical component is inserted.

8. The connecting member of claim 1, wherein the body has a rectangular parallelepiped shape extending along the side surfaces of the battery modules, and a side surface of the seating portion has a curved surface.

9. The connecting member of claim 1, wherein the body is made in a hollow shape, and reinforcing ribs are provided in multiple stages inside the body.

10. A battery module assembly comprising:
battery modules; and
the battery module connecting member according to claim 9, which is mounted between adjacent side surfaces of the battery modules and connects the battery modules.

11. A battery module assembly comprising:
battery modules; and
the battery module connecting member according to claim 8, which is mounted between adjacent side surfaces of the battery modules and connects the battery modules.

12. A battery module assembly comprising:
battery modules; and
the battery module connecting member according to claim 7, which is mounted between adjacent side surfaces of the battery modules and connects the battery modules.

13. A battery module assembly comprising:
battery modules; and
the battery module connecting member according to claim 6, which is mounted between adjacent side surfaces of the battery modules and connects the battery modules.

14. A battery module assembly comprising:
battery modules; and
the battery module connecting member according to claim 5, which is mounted between adjacent side surfaces of the battery modules and connects the battery modules.

15. A battery module assembly comprising:
battery modules; and
the battery module connecting member according to claim 4, which is mounted between adjacent side surfaces of the battery modules and connects the battery modules.

16. A battery module assembly comprising:
battery modules; and
the battery module connecting member according to claim 3, which is mounted between adjacent side surfaces of the battery modules and connects the battery modules.

17. A battery module assembly comprising:
battery modules; and
the battery module connecting member according to claim 2, which is mounted between adjacent side surfaces of the battery modules and connects the battery modules.

18. A battery module assembly comprising:
battery modules; and
the battery module connecting member according to claim 1, which is mounted between adjacent side surfaces of the battery modules and connects the battery modules.
